(19) United States
(12) Patent Application Publication
(10) Pub. No.: US 2015/0009220 A1
(43) Pub. Date: Jan. 8, 2015

(54) SHUTTER ASSEMBLIES INCORPORATING OUT-OF-PLANE MOTION RESTRICTION FEATURES

(71) Applicant: Pixtronix, Inc., San Diego, CA (US)

(72) Inventor: Joyce H. Wu, Somerville, MA (US)

(21) Appl. No.: 13/933,962

(22) Filed: Jul. 2, 2013

(51) Int. Cl. G02B 26/02; G06T 1/20

(52) U.S. Cl. CPC G02B 26/02; G06T 1/20
USPC 345/501; 359/230

(57) ABSTRACT

This disclosure provides systems and apparatus for restricting out-of-plane motion during light modulator operation. In one aspect, an apparatus includes a light modulator that has a conductive movable light blocking component supported over a light blocking layer. The light modulator includes an electrostatic actuator that has a drive electrode configured to move the light blocking component laterally with respect to an aperture formed through the light blocking layer. The light modulator further includes an elongated electrode separate from the drive electrode and electrically isolated from the movable light blocking component. The elongated electrode extends alongside a path traveled by the movable light blocking component for substantially the entire length of the path.

### TECHNICAL FIELD

This disclosure relates to displays, and in particular, to shutter assemblies for displays.

### DESCRIPTION OF THE RELATED TECHNOLOGY

Electromechanical systems (EMS) shutter-based display elements have been demonstrated to effectively modulate light in displays. However, in some implementations, the shutters in such display elements exhibit a propensity to move out of their desired plane of motion. Such out of plane motion can result in the shutters contacting other surfaces of the display. Such contact could lead to damage to the shutters or the shutters adhering to the other surfaces due to stiction.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a light modulator having a conductive movable light blocking component supported over a light blocking layer. The light modulator also includes an electrostatic actuator that has a drive electrode configured to move the light blocking component laterally with respect to an aperture formed through the light blocking layer. The light modulator further includes an elongated electrode separate from the drive electrode and electrically isolated from the movable light blocking component. The elongated electrode extends alongside a path traveled by the movable light blocking component for substantially the entire length of the path.

In some implementations, during operation of the light modulator, the elongated electrode is maintained at a potential difference with respect to the movable light blocking component. In some implementations, the elongated electrode is configured to provide a voltage throughout the entire length of the elongated electrode.

In some implementations, the movable light blocking component is coupled to a cantilever beam that forms a portion of the electrostatic actuator. In some implementations, the elongated electrode is curved such that the distance between the elongated electrode and the movable light blocking component remains substantially constant along the path traveled by the movable light blocking component. In some implementations, the path traveled by the movable light blocking component is a substantially straight line.

In some implementations, the elongated electrode is positioned beside one side of the movable light blocking component. The light modulator further includes a second elongated electrode positioned on an opposite side of the movable light blocking component relative to the elongated electrode. In some implementations, the light modulator shares the elongated electrode with a neighboring light modulator. In some implementations, the elongated electrode extends parallel to the path traveled by the light blocking component.

In some implementations, the apparatus includes a display, a processor that is configured to process image data and a memory device that is configured to communicate with the processor. In some implementations, the apparatus includes a driver circuit configured to send at least one signal to the display and the processor is further configured to send at least a portion of the image data to the driver circuit. In some implementations, the apparatus includes an image source module configured to send the image data to the processor. In some such implementations, the image source module includes at least one of a receiver, transceiver, and transmitter. In some implementations, the apparatus includes an input device configured to receive input data and to communicate the input data to the processor. In some implementations, the light modulators include electromechanical system (EMS) light modulators. In some implementations, the apparatus includes a first substrate configured to support an array of the light modulators and a second substrate separated from the first substrate.

Another innovative aspect of the subject matter described in this disclosure can be implemented in an apparatus that includes a light modulator that has a conductive movable light blocking component supported over a light blocking layer. The light modulator also includes an electrostatic actuator that has a drive means for moving the light blocking component laterally with respect to an aperture formed through the light blocking layer. The light modulator further includes a plane maintaining means for restricting the light blocking component from moving away from its desired path of travel. The plane maintaining means is separate from the drive means. The plane maintaining means extends alongside a path traveled by the movable light blocking component for substantially the entire length of the path.

In some implementations, during operation of the light modulator, the plane maintaining means is maintained at a potential difference with respect to the movable light blocking component. In some implementations, the plane maintaining means is configured to provide a voltage throughout the entire length of the plane maintaining means.

In some implementations, the movable light blocking component is coupled to a cantilever beam that forms a portion of the electrostatic actuator. In some implementations, the plane maintaining means is curved such that the distance between the plane maintaining means and the movable light blocking component remains substantially constant along the path traveled by the movable light blocking component.

In some implementations, the elongated electrode is positioned beside one side of the movable light blocking component. The light modulator further includes a second elongated electrode positioned on an opposite side of the movable light blocking component relative to the elongated electrode.

Details of one or more implementations of the subject matter described in this specification are set forth in the accompanying drawings and the description below. Although the examples provided in this summary are primarily described in terms of EMS-based displays, the concepts provided herein may apply to other types of displays, such as liquid crystal displays (LCDs), organic light emitting diode (OLED) displays, electrophoretic displays, and field emission displays, as well as to other non-display EMS devices, such as EMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example schematic diagram of a direct-view microelectromechanical system (MEMS)-based display apparatus.

FIG. 1B shows an example block diagram of a host device.

FIGS. 2A-2C show plan views of an example shutter assembly.

FIGS. 2D and 2E show example cross sectional views of the shutter assembly shown in FIGS. 2A-2C.

FIG. 3 shows a schematic diagram of an example control matrix.

FIGS. 4-7 show plan views of an example shutter assembly.

FIGS. 8A-8E show example cross-sectional views of stages of construction of an example display apparatus.

FIGS. 9A and 9B show example system block diagrams illustrating a display device that includes a set of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Shutter assemblies can incorporate secondary electrostatic actuators to help maintain the position of their shutters within a desired plane. That is, a shutter assembly can include one or more primary actuators configured to move a shutter within a plane between its light modulating states. In addition, the shutter assembly can have an extra electrostatic actuator that is configured to help maintain the in-plane position of the shutter. The secondary electrostatic actuator can include the shutter as one electrode. An elongated conductive beam that extends alongside the shutter's direction of travel, can serve as the other electrode. In some implementations, the elongated conductive beam can extend parallel to the shutter's direction of travel. In some implementations, the elongated conductive beam can extend parallel to the shutter's direction of travel along the shutter's travel path. In some implementations, the elongated conductive beam can be positioned at about the height of the shutter. In some implementations, a potential difference is applied across the shutter and the elongated electrode. If the shutter begins to move out of its desired plane of motion, the electrostatic force imparted by the potential difference draws the shutter back into the desired plane of motion. In some implementations, the shutter assembly can include two elongated conductive beams positioned alongside opposite sides of the shutter parallel to the shutter's direction of travel. In some implementations, the adjacent shutter assemblies can be separated by a pair of elongated conductive beams, each of which is configured to restrict a respective shutter from moving away from the shutter's desired plane of motion.

In some implementations, the shutter assembly can include a shutter that is supported over a corresponding aperture by a cantilever beam, which serves as a load electrode. In some implementations, the cantilever beam forms a component of a primary shutter open actuator and a primary shutter close actuator that control the movement of the shutter. Drive electrodes configured to move the shutter rotationally along a plane of motion are positioned on either side of the cantilever beam. The shutter is supported by the cantilever beam and has a curved path of travel. In some implementations, the shutter assembly includes a curved elongated electrode positioned alongside a curved end of the shutter. In some implementations, the elongated electrode forgoes having a curvature, and instead, it is formed as a straight beam tangential to about the middle of the shutter's path of travel. The straight beam can impart a similar restoring force on the shutter.

Particular implementations of the subject matter described in this disclosure can be implemented to realize one or more of the following potential advantages. In particular, shutter assemblies that include secondary electrostatic actuators can maintain the position of their shutters substantially within a desired plane by restricting movement of the shutter out of its plane of motion. By restricting a shutter from moving out of its intended plane of motion, the risk of shutters coming into contact with other surfaces is mitigated, thus avoiding the damage and/or failures such contact can cause. This improves the reliability of the shutter and the display in which it is incorporated. Moreover, by maintaining the position of the shutters substantially within a desired plane, the shutters and the load electrodes that support the shutters are better aligned with opposing drive electrodes resulting in stronger electrostatic forces between the load and corresponding drive electrodes. This results in better performance. The secondary electrostatic actuator also can block other parasitic voltages or fields from affecting the movement of the shutter. In some implementations, by coating one or more surfaces of the secondary electrostatic actuator with an anti-reflective or light-absorbing material, the secondary electrostatic actuator can serve to absorb light that leaks from the region around the shutter. In addition, the secondary electrostatic actuator also can serve to absorb light that leaks out from the shutter. Moreover, the secondary electrostatic actuator also can maintain the shutter in its desired plane during operations that could potentially knock the shutter out of its desired plane. Examples of such operations can include a fluid fill operation of the display apparatus.

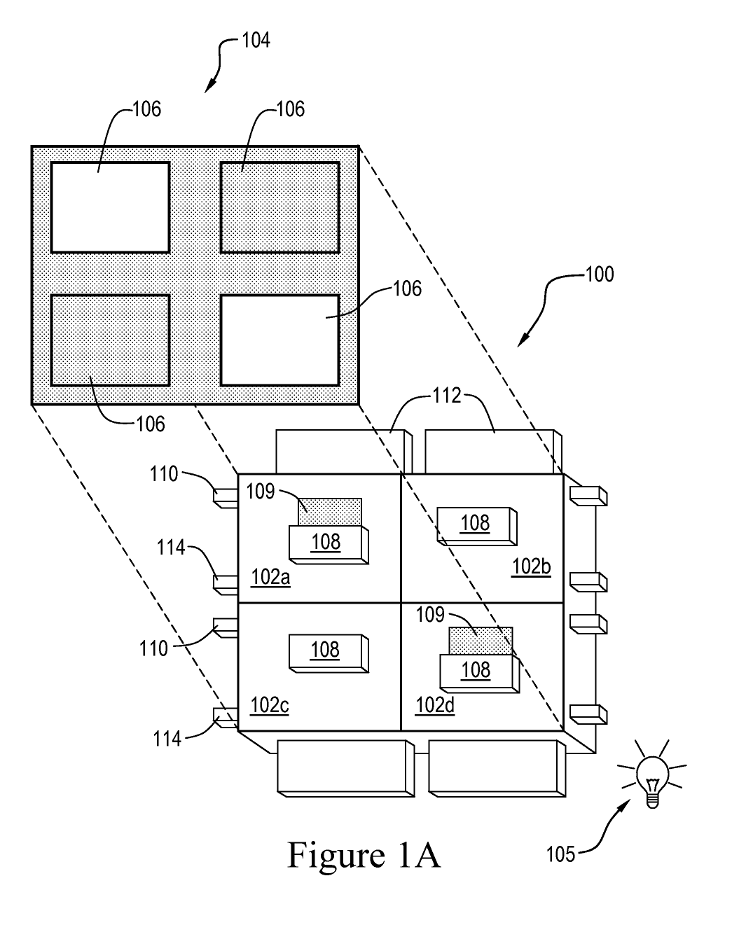

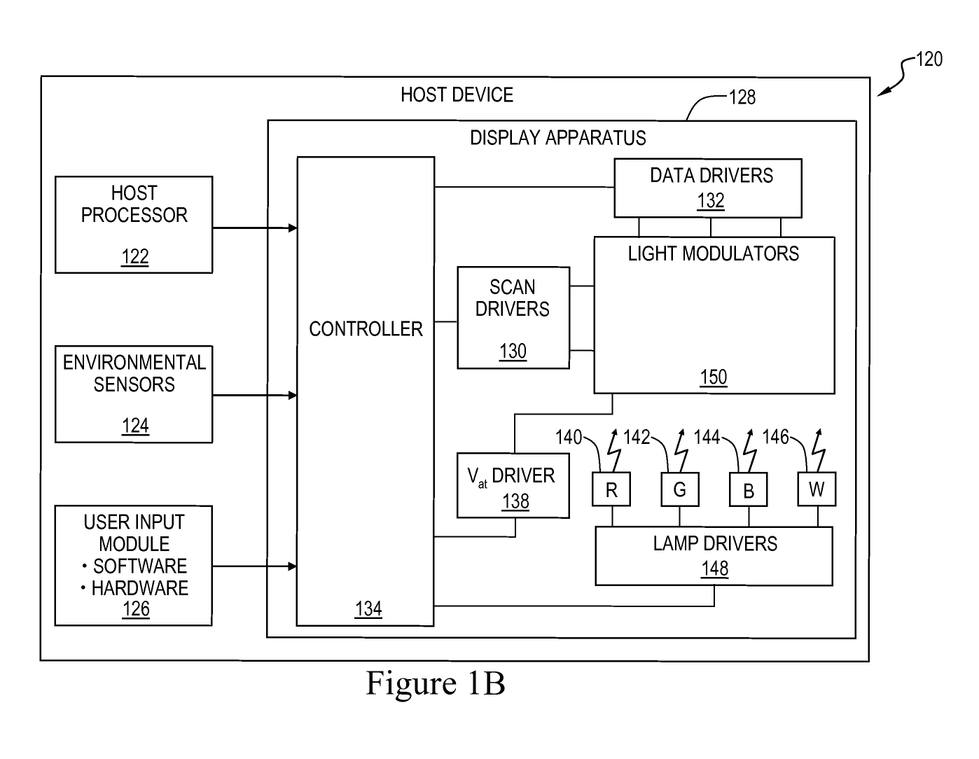

FIG. 1A shows a schematic diagram of a direct-view microelectromechanical system (MEMS)-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. In some implementations, the shutter 108 may be part of a shutter assembly. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (e.g., interconnects 110, 112 and 114), including at least one write-enable interconnect 110 (also referred to as a scan-line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows an example of a block diagram 120 of a host device (i.e., cell phone, smart phone, PDA, MP3 player, tablet, e-reader, etc.). The host device 120 includes a display apparatus 128, a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, and lamp drivers 148. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the light modulators, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the controller 134). The controller sends data to the data drivers 132 in a mostly serial fashion, organized in sequences, which in some implementations may be predetermined, grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all light modulators within the array of light modulators, for instance by supplying voltage to a series of common interconnects 114. In some other implementations, the common drivers 138, following commands from the controller 134, issue voltage pulses or signals to the array of light modulators, for instance global actuation pulses which are capable of driving and/or initiating simultaneous actuation of all light modulators in multiple rows and columns of the array.

Each of the drivers (e.g., scan drivers 130, data drivers 132 and common drivers 138) for different display functions can be time-synchronized by the controller 134. Timing commands from the controller coordinate the illumination of red, green and blue and white lamps (140, 142, 144 and 146 respectively) via lamp drivers 148, the write-enabling and sequencing of specific rows within the array of pixels, the output of voltages from the data drivers 132, and the output of voltages that provide for light modulator actuation.

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array is synchronized with the illumination of the lamps 140, 142, 144 and 146 such that alternate image frames are illuminated with an alternating series of colors, such as red, green and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In some alternate implementations, four or more lamps with primary colors can be employed in display apparatus 100, employing primaries other than red, green and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the modulator array by a sequential addressing of individual rows, also referred to as scan lines. For each row or scan line in the sequence, the scan driver 130 applies a write-enable voltage to the write enable interconnect 110 for that row of the array, and subsequently the data driver 132 supplies data voltages, corresponding to desired shutter states, for each column in the selected row. This process repeats until data has been loaded for all rows in the array. In some implementations, the sequence of selected rows for data loading is linear, proceeding from top to bottom in the array. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array, for instance by addressing only every fifth row of the array in sequence.

In some implementations, the process for loading image data to the array is separated in time from the process of actuating the shutters 108. In these implementations, the modulator array may include data memory elements for each pixel in the array, and the control matrix may include a global actuation interconnect for carrying trigger signals, from common driver 138, to initiate simultaneous actuation of shutters 108 according to data stored in the memory elements.

In alternative implementations, the array of pixels and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

A shutter assembly can incorporate primary electrostatic actuators to move a shutter between its light modulating states. In addition, the shutter assembly can have a secondary electrostatic actuator that is configured to reliably keep the shutter within its desired plane of motion. That is, the secondary electrostatic actuator is configured to restrict the shutter from moving too far out of its desired plane of motion. The shutter serves as one of the electrodes of the secondary electrostatic actuator. An elongated conductive beam that extends alongside the shutter's direction of travel serves as the other electrode. In some implementations, the elongated conductive beam can extend parallel to the shutter's direction of travel. The elongated conductive beam is positioned at about the height of the shutter. A potential difference is applied across the shutter and the elongated electrode. This restricts the shutter from moving out of its desired plane of motion by imparting an attractive electrostatic force that causes the shutter to stay aligned with the desired plane of motion.

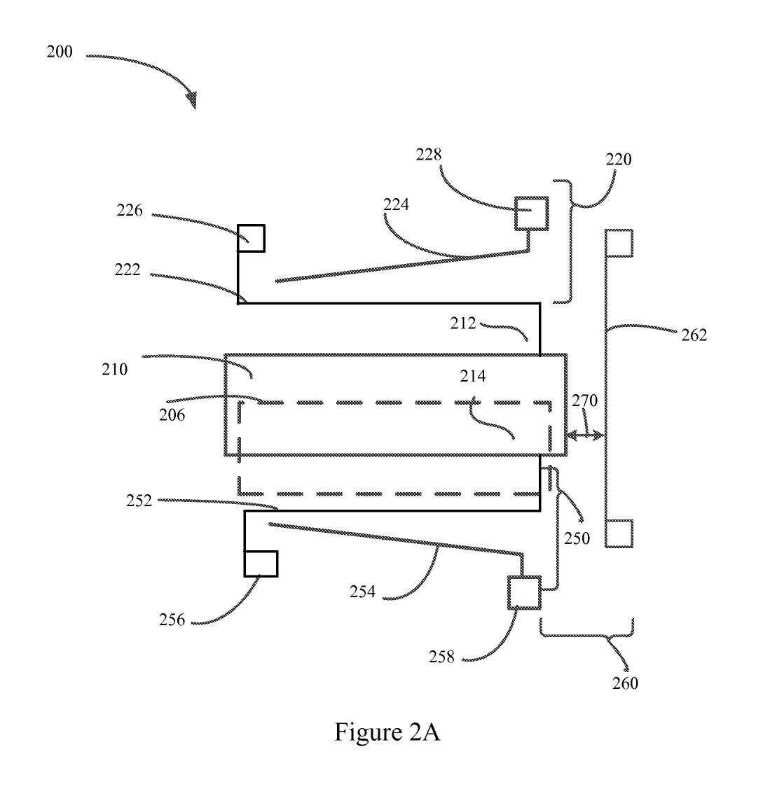

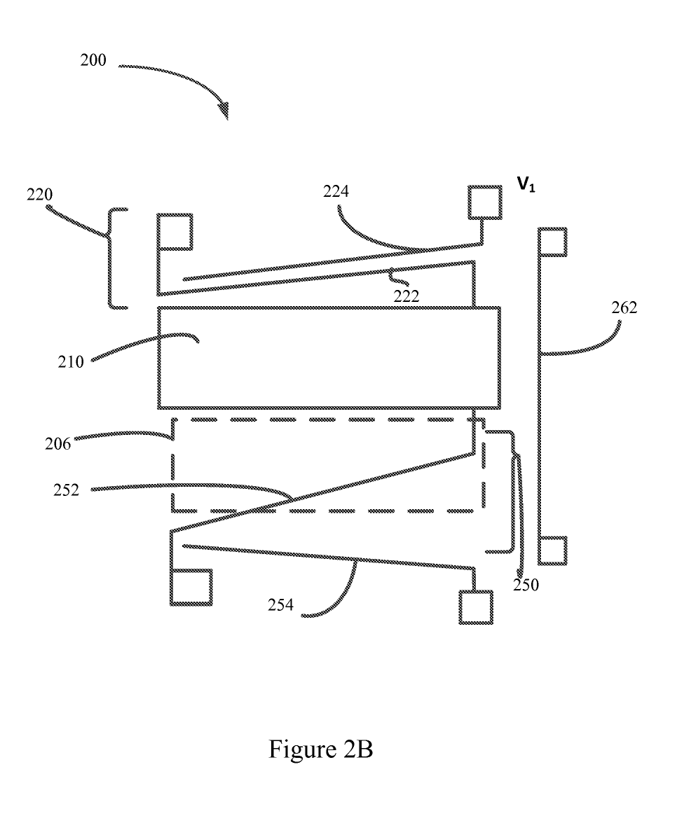

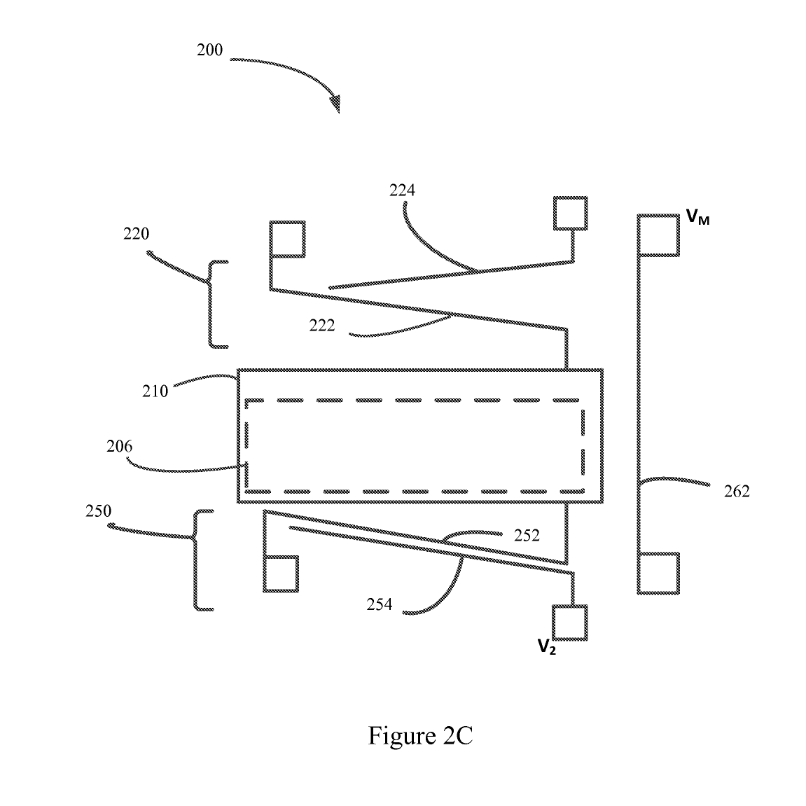

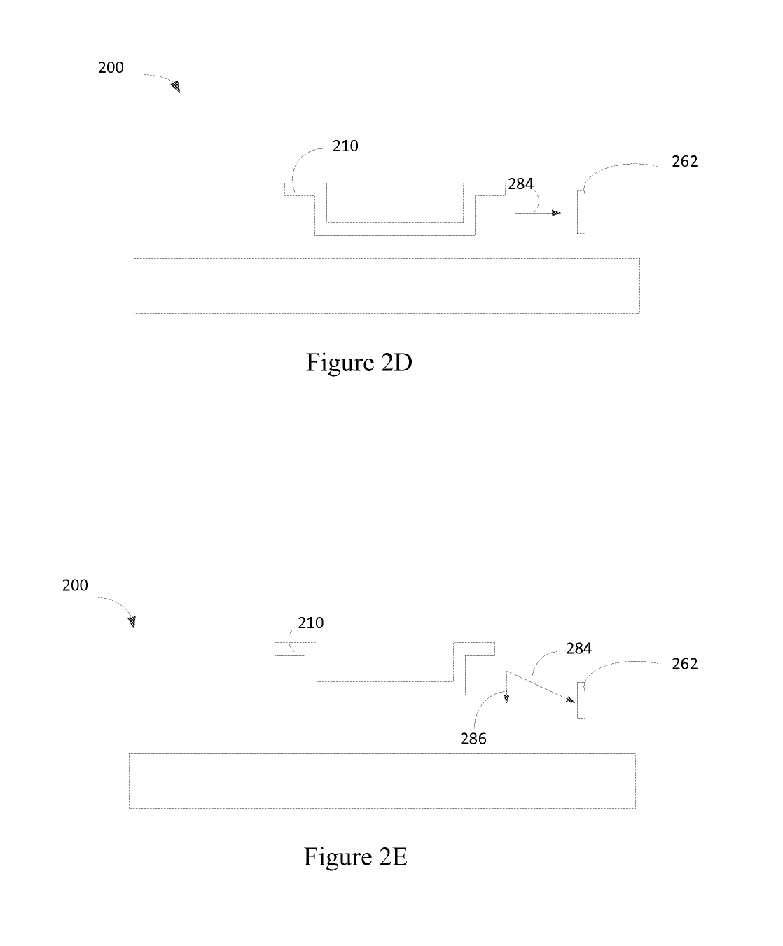

FIGS. 2A-2C show plan views of an example shutter assembly 200. FIG. 2A shows the shutter assembly 200 in a relaxed or unactuated state. FIG. 2B shows the shutter assembly 200 in a fully light transmissive state or open state. FIG. 2C shows the shutter assembly 200 in a light blocking state or closed state.

Referring to FIGS. 2A-2C, the shutter assembly 200 includes a shutter 210 that is driven along an axis by two primary electrostatic actuators, a shutter open actuator 220 and a shutter close actuator 250. The axis along which the shutter is driven is substantially parallel to a plane of an underlying light blocking layer through which an aperture 206 is formed. Stated in another way, the shutter is driven substantially laterally with respect to an underlying aperture 206 formed through a light blocking layer. The shutter 210 is supported over the aperture 206 by portions of a shutter open actuator 220 and a shutter close actuator 250. In addition to the primary electrostatic actuators, the shutter assembly 200 includes a secondary electrostatic actuator 260 that is configured to help maintain the in-plane position of the shutter. The secondary electrostatic actuator 260 includes the shutter 210, which serves as a first electrode, and an elongated beam electrode 262 positioned beside and parallel to the path of travel of the shutter 210, which serves as an opposing electrode.

The shutter open actuator 220 is configured to move the shutter 210 towards the fully light transmissive state in which the shutter 210 does not overlap any portion of the corresponding aperture 206. The shutter open actuator 220 includes a first load electrode 222 that is coupled to one end 212 of the shutter 210. The first load electrode 222 is supported by a load anchor 226. The shutter open actuator 220 also includes a first drive electrode 224 positioned proximate the first load electrode 222. The first drive electrode 224 is supported by a drive anchor 228.

The shutter open actuator 220 is configured to move the shutter 210 to an open, or fully light transmissive, state. The load electrode 222 is compliant and configured to deform towards the drive electrode 224. In addition, the drive electrode 224 is compliant and configured to deform towards the load electrode 222. When a sufficiently large actuation voltage is applied to the drive electrode 224, the load electrode 222 and the drive electrode 224 deform towards one another. As the load electrode 222 deforms towards the drive electrode 224, the load electrode 222 causes the shutter 210 to move towards the drive electrode 224 and away from the corresponding aperture 206 through which light can be transmitted. When the load electrode 222 is fully deformed such that the drive electrode 224 and the load electrode 222 are fully engaged, no portion of the shutter 210 overlaps the corresponding aperture 206. As a result, none of the light passing through the aperture 206 is blocked by the shutter 210. This state of the shutter assembly is shown in FIG. 2B.

The shutter close actuator 250 is substantially similar to the shutter open actuator 220. However, in contrast to the shutter open actuator 220, the shutter close actuator 250 is configured to move the shutter 210 towards a closed, or light blocking, state in which the shutter 210 completely overlaps the corresponding aperture 206. The shutter close actuator 250 includes the second load electrode 252 that is coupled to another end 214 of the shutter 210. The second load electrode 252 is supported by a second load anchor 256. The shutter close actuator 250 includes a second drive electrode 254 positioned proximate the second load electrode 252. The second drive electrode 254 is supported by a second drive anchor 258.

The shutter close actuator 250 is configured to move the shutter 210 to a light blocking or closed state. The second load electrode 252 is compliant and configured to deform towards the second drive electrode 254 when a sufficiently large actuation voltage is applied to the second drive electrode 254. As the second load electrode 252 deforms towards the second drive electrode 254, the second load electrode 252 causes the shutter 210 to move towards the second drive electrode 254. When the second load electrode 252 is fully deformed such that the second drive electrode 254 and the second load electrode 252 are fully engaged, the shutter 210 overlaps the corresponding aperture 206 such that substantially all of the light passing through the aperture 206 is blocked by the shutter 210. This state of the shutter assembly is shown in FIG. 2C.

As described above, the secondary electrostatic actuator 260 is configured to restrict the shutter from moving out of its desired plane of motion. The secondary electrostatic actuator 260 includes the shutter 210 and the elongated beam electrode 262 alongside the path of travel of the shutter 210. In some implementations, the elongated beam electrode 262 is positioned beside an edge of the shutter 210 that is parallel to the path of travel of the shutter 210. In some implementations, the elongated beam electrode is positioned such that the elongated beam electrode is at about the same height as the shutter 210. In some implementations, the elongated beam electrode 262 extends along substantially the entire length of the path the shutter 210 travels between its two actuated states. As such, the length of the elongated beam electrode 262 has a length that is greater than or substantially equal to the sum of the length of the side of the shutter 210 opposing the elongated beam electrode 262 and the distance the shutter travels between the open state and the closed state.

The elongated beam electrode 262, in some implementations, is spaced as close to the shutter 210 as possible given the limitations of the patterning process used to form the shutter 210 and elongated beam electrode 262, thereby reducing the voltage needed to be applied for the elongated beam electrode 262 to effectively maintain the shutter 210 within its desired plane of motion. For example, in some implementations, the elongated beam electrode 262 is spaced between about 1 and about 10 microns away from the side of the shutter 210, such as between about 2 and about 5 microns.

In some implementations, the secondary electrostatic actuator 260 is actuated just before, at the same time as, or after either one of the primary actuators 220 or 250 is actuated. In some implementations, the potential difference is applied constantly, other than to accommodate polarity reversal schemes, which may be implemented to reduce the likelihood of charge buildup on the various electrodes of the actuators included in the shutter assembly 200. In some implementations, to actuate the secondary actuator 260 a relatively small voltage, for example between about 1V and about 10V, such as between about 3V and about 5V, is applied to the elongated beam electrode 262. In some other implementations, other voltage levels are applied. The specific voltage selected is based on the specific mechanical properties of the shutter assembly 200 to provide sufficient force to maintain the shutter within its desired plane of motion without imparting a force, which in some implementations may be perpendicular, to the path of travel of the shutter that is sufficiently large to move the shutter out of its intended path of travel or to slow its actuation. In some implementations, both the first and second electrostatic actuators 220 and 250 and the secondary electrostatic actuator 260 can be electrically connected to a single voltage source. In some such implementations, one or more electrical components, such as diodes, switches, resistors, amongst others, can be utilized to provide appropriate voltages to each of the actuators. In some implementations, one or more electrical components, such as a diode, may be placed between the shutter 210 and the secondary actuator 260 to provide a potential difference sufficient to maintain the shutter within its desired plane of motion. In some implementations, one or more of the first and second electrostatic actuators 220 and 250 and the secondary electrostatic actuator 260 can be electrically connected to distinct voltage sources.

FIG. 2B shows the shutter assembly 200 in the fully light transmissive state. In this state, the first drive electrode 236a is electrostatically engaged with the first load electrode 220. By applying an actuation voltage V₁ to the first drive electrode 224, an electrostatic force between the drive electrode 224 and the first load electrode 222 is created. The electrostatic force attracts the first load electrode 222 towards the first drive electrode 224 causing the first load electrode 222 to deform towards the first drive electrode 224. The deformation of the load electrode 222 causes the shutter 210, which is coupled to the first load electrode 222 to move closer to the first drive electrode 224 such that the shutter 210 is offset from the corresponding aperture 206 and no longer overlaps any part of the corresponding aperture 206. As such, the shutter assembly 200 allows the light passing through the corresponding aperture 206 to also pass by the shutter 210. In some implementations, the first drive electrode 224 also serves as a mechanical stop for the first load electrode 222, thereby defining one end of the range of travel of the shutter 210.

FIG. 2C shows the shutter assembly 200 in the non-light transmissive state or closed state. To achieve this state, an actuation voltages V₂ is applied to the second drive electrode 254. By applying the actuation voltage V₂ to the second drive electrode 254, an electrostatic force between the second drive electrode 254 and the second load electrode 252 is created. The electrostatic force attracts the second load electrode 252 towards the second drive electrode 254 causing the second load electrode 252 to deform towards the second drive electrode 254. The deformation of the second load electrode 252 causes the shutter 210, which is coupled to the second load electrode 252 to move closer to the second drive electrode 254 such that the shutter 210 completely overlaps the corresponding aperture 206. As such, the shutter assembly 200 blocks substantially all of the light passing through the corresponding aperture 206. In some implementations, the second drive electrode 254 also serves as a mechanical stop for the second load electrode 252, thereby defining one end of the range of travel of the shutter 210.

In some implementations, V₁ and V₂ are substantially equal. In some other implementations, V₁ and V₂ may differ from one another. Each of V₁ and V₂ range from about 10V to about 50V, depending on the configuration and mechanical properties of the shutter assembly 200.

FIGS. 2D and 2E are cross sectional views of the shutter assembly 200 shown in FIGS. 2A-2C. FIG. 2D shows the shutter assembly 200 in an in-plane position. FIG. 2E shows the shutter assembly 200 in an out-of-plane position.

As shown in FIG. 2D, the elongated beam electrode 262 is positioned at about the same height as the shutter 210. When the shutter 210 is within its desired plane of motion, the elongated beam electrode 262 imparts a sideways force 284 on the shutter 210. To limit movement of the shutter 210 towards the elongated beam electrode 262, the voltage on the elongated beam electrode 262 is kept relatively low, for example, between about 5V and about 25V, such as between about 15 and about 20V. In some implementations, the voltage on the elongated beam electrode 262 is less than the actuation voltage applied to the first and second primary electrostatic actuators 220 and 250.

As the shutter 210 begins to move out of its desired plane, as shown in FIG. 2E, the electrostatic field between the shutter 210 and the elongated beam electrode 262 creates an electrostatic force 284 that acts on the shutter 210. The electrostatic force 284 includes a vector component 286 normal to the shutter's plane of motion in a direction opposite to the shutter's displacement out of the plane of motion. The electrostatic force 284 helps restore the shutter 210 to its desired plane of motion.

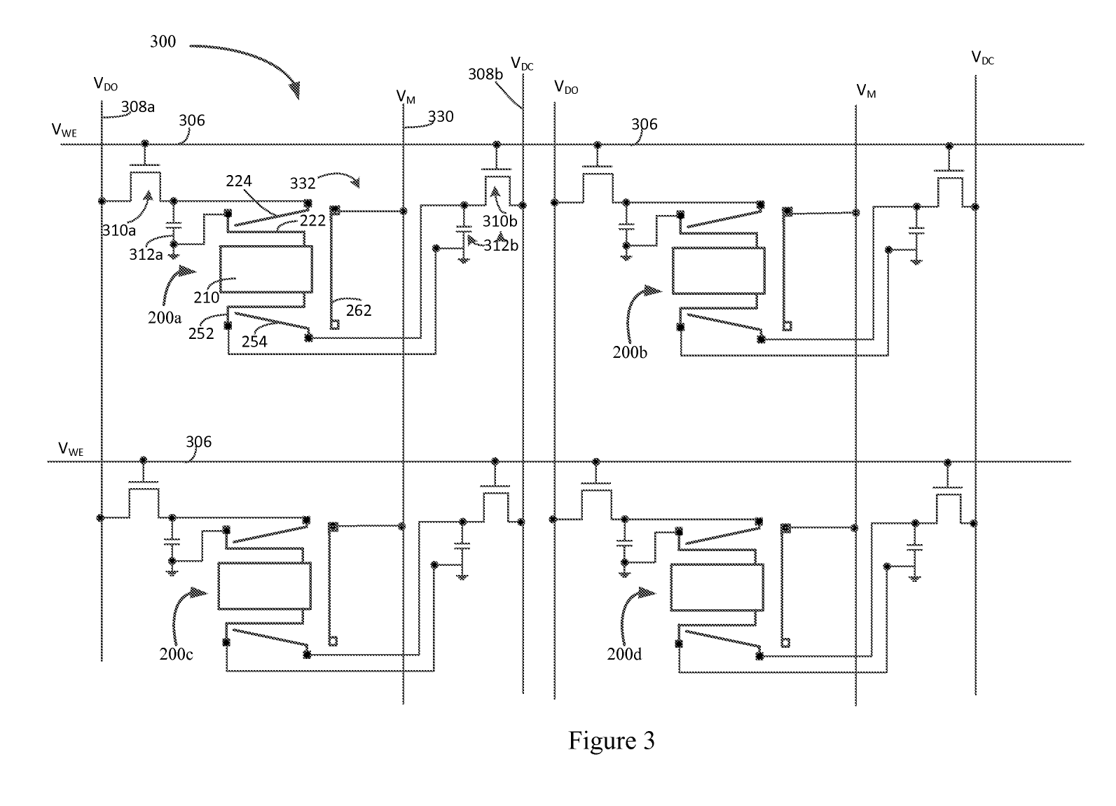

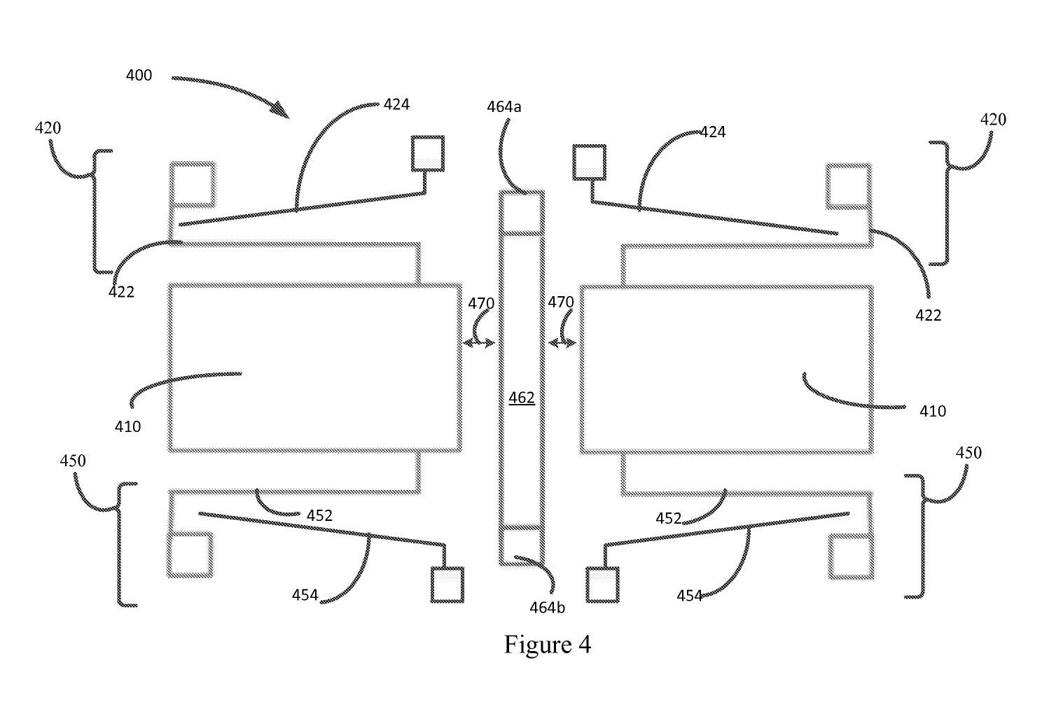

FIG. 3 shows a schematic diagram of an example control matrix 300. The control matrix 300 is suitable for controlling an array of shutter assemblies that include secondary actuators, similar to the shutter assembly 200 shown in FIGS. 2A-2E. The control matrix 300 also can be suitable for controlling other shutter assemblies that include a single side actuator in addition to a shutter open and a shutter close actuator, for example, shutter assemblies 400, 500 and 700, respectively shown in FIGS. 4, 5 and 7, below. A portion of the array of shutter assemblies including shutter assemblies 200a-200d is shown in FIG. 3. However, merely to simplify the explanation, aspects of the control matrix 300 are described herein in relation to the shutter assembly 200a.

For each row of the shutter assemblies 200, the control matrix 300 includes a scan-line interconnect 306. For each column of shutter assemblies 200, the control matrix 300 includes two data interconnects, a shutter-open data interconnect 308a and a shutter-close data interconnect 308b, and a secondary actuator electrode interconnect 330. The data interconnects 308a and 308b carry the voltages needed to actuate the shutter assemblies 200, and thus serve the dual roles of providing both data to a shutter assembly, as well as an actuation voltage. Thus the data interconnects 308a and 308b can be considered both data interconnects and actuation interconnects.

Each data interconnect 308a and 308b couples to a corresponding transistor 310a or 310b and a capacitor 312a or 312b. The gates of all of the transistors 310a and 310b along a row of the shutter assemblies 200 are coupled to the scan-line interconnect 306 that corresponds to that row. For a given shutter assembly 200 in the row, the drain of the transistor 310a is coupled to the shutter-open data interconnect 308a and the drain of the transistor 310b is coupled to the shutter-close data interconnect 308b. The source of the transistor 310a is coupled in parallel to the capacitor 312a and the drive electrode 224 of the shutter open actuator 220. The source of the transistor 310b is coupled in parallel to the capacitor 312b and to the drive electrode 254 of the shutter close actuator 250. The load electrodes 222 and 252 of the shutter open and shutter close actuators 220 and 250 are coupled to ground.

Each secondary actuator electrode interconnect 330 carries a plane maintaining voltage V_{PM} needed to restrict the shutter 210 from moving out of its desired plane of motion. The secondary actuator electrode interconnect 330 is coupled to the secondary electrodes 262 of shutter assemblies 200 that belong to a particular column of the array of shutter assembly. In some implementations, the plane maintaining voltage V_{PM} is provided to the secondary actuator electrode interconnects 330 of the array at all times. In some implementations, the plane maintaining voltage V_{PM} may be provided throughout the entire length of time the shutter travels between states. In some implementations, the plane maintaining voltage V_{PM} may be applied whenever the shutter is caused to move. For example, the plane maintaining voltage V_{PM} may be provided to the secondary actuator electrode interconnects 330 only when the actuation voltage is applied to either the shutter open actuator 220 or the shutter close actuator 250. In some implementations, the plane maintaining voltage V_{PM} may range from about 5V-25V, such as about 15V to about 20V.

In operation, the control matrix 300 addresses and actuates each row of shutter assemblies 200, one row at a time. Specifically, at the beginning of a row addressing and actuation cycle, a write-enabling voltage V_{WE} is applied to a corresponding scan-line interconnect 306, turning on the transistors 310a and 310b of each shutter assembly in the row associated with that scan-line interconnect 306. Then, actuation voltages are selectively applied to the data interconnects 308a and 308b for each column of the shutter assemblies 200 depending on image data loaded into the control matrix, thereby actuating the actuators that receive the actuation voltage. For the shutter open actuators 220 and the shutter close actuators 250, the actuation voltage (V_{DO} or V_{DC}) may range from about 10V-50V, such as between about 15V and about 40V, depending on the specific configuration of the shutter assembly 200. As described above, the plane maintaining voltage V_{PM} is applied to the secondary electrode 262 and is sufficiently large to exert a force on the shutter 210 that substantially prevents the shutter from moving out of its plane of motion.

After the shutters 210 enter their desired states, the control matrix 300 removes the voltage from the scan-line interconnect 306, and begins the cycle again for the next row of the shutter assemblies 200.

The control matrix 300 is merely an example of one type of control matrix that can be used to control the shutter assemblies 200. A person of ordinary skill in the art will readily appreciate that a wide variety of control matrices may be employed in conjunction with the shutter assembly 200. Such control matrices may incorporate relatively low voltage data interconnects that are separate from a set of higher voltage actuation interconnects, as well as additional common interconnects that couple to shutter assemblies in multiple rows and multiple columns of a display. The shutter assemblies also may include latch or other cross-coupled circuits for controlling the state of shutter assemblies using only a single data interconnect per pixel.

FIG. 4 is a plan view of a pair of example shutter assemblies 400. Each of the shutter assemblies 400 is substantially similar to the shutter assembly 200 shown in FIGS. 2A-2E. In contrast to the shutter assembly 200, though, each shutter assembly 400 includes an elongated electrode 462 that is shared with a neighboring shutter assembly. The elongated electrode 462 extends between two sides of a pair of anchors 464 such that each shutter 410 has a portion of the elongated electrode 462 about an equal distance 470 from one of its edges.

As shown in FIG. 4, the orientation of neighboring shutter assemblies 400 are reversed or mirror-images with respect to one another. As a result, in some implementations, such as the implementation shown in FIG. 4, the load electrodes 422 and 452 of the shutter assemblies 400 each couple to their respective shutters 410 at portions of the shutters 410 that are closer to the elongated electrode 462.

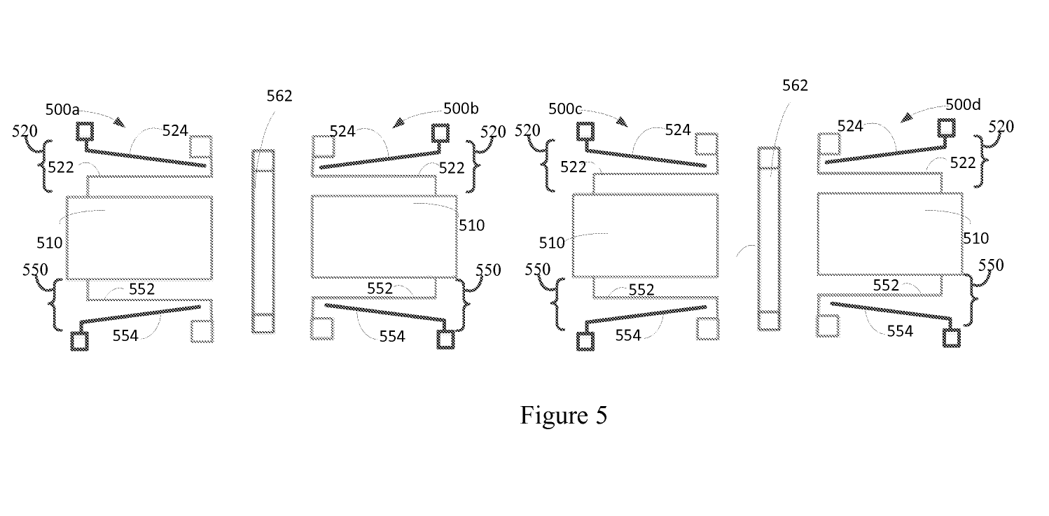

FIG. 5 is a plan view of a plurality of example shutter assemblies 500a-500d, generally referred to as shutter assemblies 500. Each of the shutter assemblies 500 is substantially similar to the shutter assemblies 400 shown in FIG. 4. In contrast to the shutter assembly 400, though, the load electrodes 522 and 552 of the shutter assemblies 500 each couple to their respective shutters 510 at portions of the shutters 510 that are farther away from the elongated electrode 562. Both this shutter layout, and the shutter layout shown in FIG. 4 provide for common stabilization of adjacent shutter assemblies 400 and 500. They also allows for neighboring shutter assemblies 400 and 500 to more readily share certain interconnects, such as a common secondary actuator electrode interconnect.

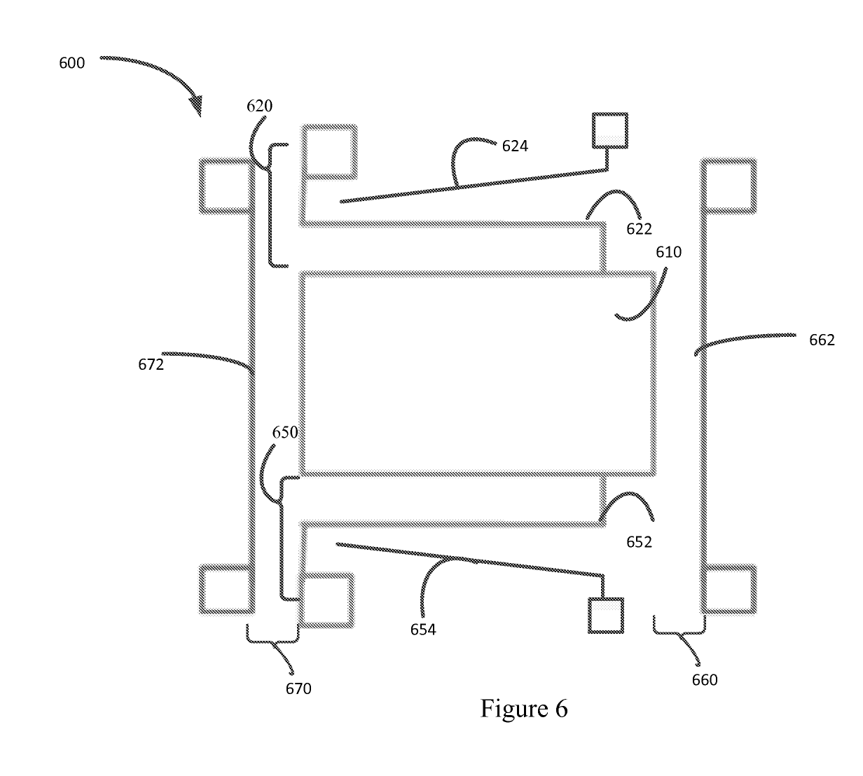

FIG. 6 is a plan view of another example shutter assembly 600. The shutter assembly 600 is substantially similar to the shutter assemblies 200, 400 and 500 shown in FIGS. 2A-2E, 4 and 5. The shutter assembly 600, in addition to the first secondary actuator 660, includes a second secondary actuator 670. The second secondary actuator 670 generates additional restoring force to keep the shutter 610 in its desired plane of motion. The secondary electrostatic actuator 260 includes the shutter 610, which serves as the first electrode, and a second elongated beam electrode 672 which serves as an opposing electrode. The second elongated beam electrode 672 is positioned beside and parallel to the shutter 610 and on an opposite side of the shutter 610 from a first elongated electrode 662. In some implementations, the second elongated beam electrode 672 is positioned such that the second elongated beam electrode 672 is at about the same height as the shutter 610. In some implementations, the second elongated beam electrode 672 extends along substantially the entire length of the path the shutter 610 travels between its two actuated states. As such, the length of the second elongated beam electrode 672 has a length that is greater than or substantially equal to the sum of the length of the side of the shutter 610 opposing the elongated beam electrode 662 and the maximum distance the shutter travels between the open state and the closed state.

The second elongated beam electrode 672, in some implementations, is spaced as close to the shutter 610 as possible given the limitations of the patterning process used to form the shutter 610 and second elongated beam electrode 672, thereby reducing the voltage needed to be applied for the elongated beam electrode 672 to effectively maintain the shutter 610 within its desired plane of motion. For example, in some implementations, the elongated beam electrode 672 is spaced between about 1 and about 10 microns, such as about 2 and about 5 microns, away from the side of the shutter 210. By using two elongated beam electrodes 662 and 672, any sideways pulling by one of the elongated beam electrodes can be offset by the electrostatic force between the shutter and the other elongated beam electrode. In addition, using the two electrodes 662 and 672 reduces the likelihood of the shutter tilting towards one of the elongated beam electrodes.

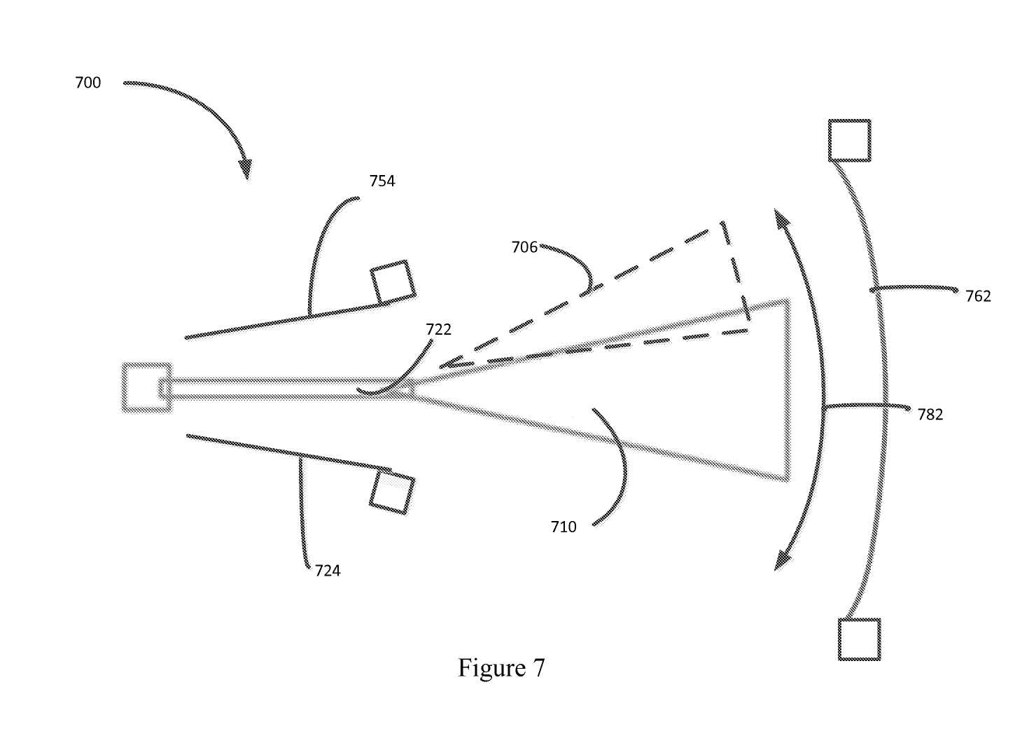

FIG. 7 is a plan view of another shutter assembly 700. The shutter assembly 700 includes a shutter 710 that is driven about an axis by two electrostatic actuators, a shutter open actuator 720 and a shutter close actuator 750. The shutter 710 is supported over a corresponding aperture 706 by a cantilever beam 724, which serves as a load electrode. In some implementations, the cantilever beam 724 forms a component of both primary actuators 720 and 750 that control the movement of the shutter 710. The shutter open actuator 720 includes a first drive electrode 724 and the cantilever beam 722, while the shutter close actuator 750 includes a second drive electrode 754 and the same cantilever beam 722. The drive electrodes 724 and 754 are positioned on either side of the cantilever beam 722.

The shutter 710 is supported by the cantilever beam 722 and has a curved path of travel 782. As such, the shutter assembly 710 includes a curved elongated electrode 762 to form a portion of a secondary actuator 760 configured to keep the shutter 710 within its desired plane of motion. Similar to the elongated electrodes 262, 462 and 562, the elongated electrode 762 is positioned at about a height of the shutter 710 above a light blocking layer, beside and parallel to the path of the shutter's movement. The elongated electrode 762 has a curvature that substantially matches the curvature of the path of travel of the shutter 710, such that it remains at about a constant distance from the shutter 710 along the path. This helps maintain a substantially constant restoring force on the shutter 710 regardless of its position along the path of travel. In some other implementations, the elongated electrode 762 forgoes having a curvature. Instead, it is formed as a straight beam tangential to about the middle of the shutter's path of travel. The straight beam can impart a similar restoring force on the shutter 710.

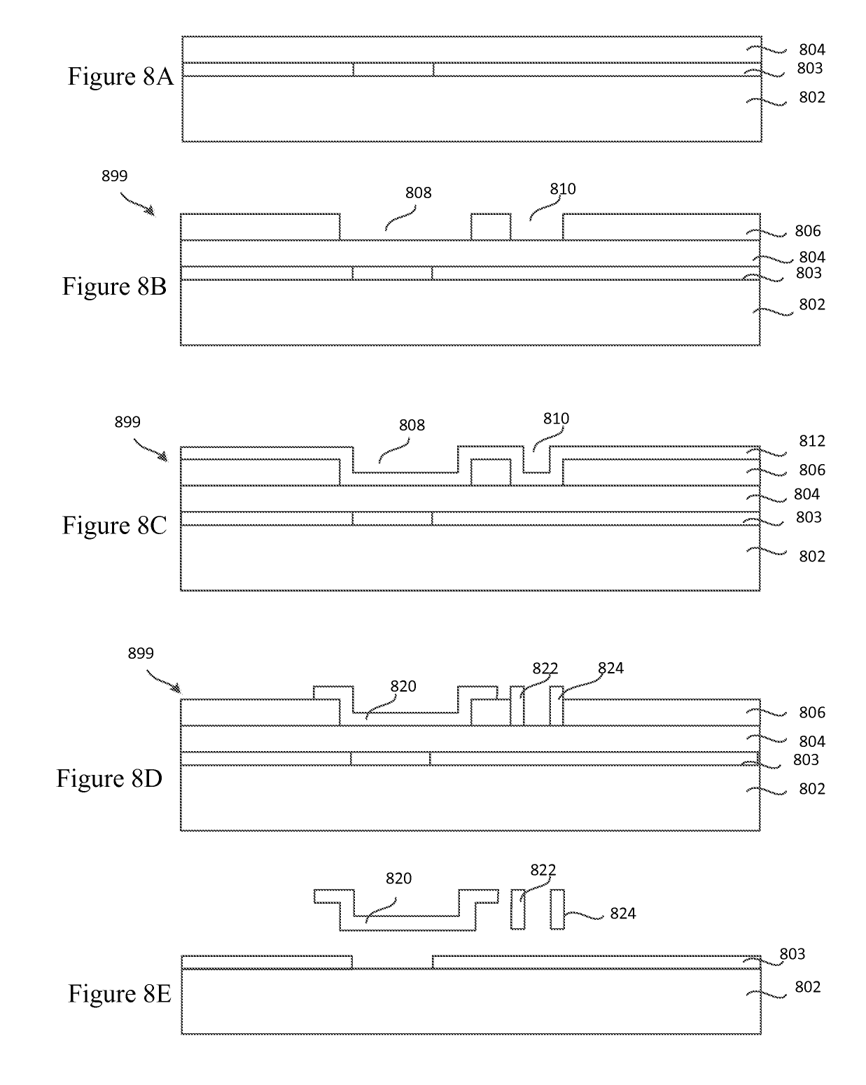

FIGS. 8A-8E show cross-sectional views of stages of construction of an example display apparatus. This process yields a shutter-based display apparatus formed on a substrate and that includes a secondary actuator that includes an elongated electrode positioned alongside the path of travel of a shutter. In the process shown in FIGS. 8A-8E, the display apparatus is formed on a mold made from a sacrificial material.

Referring to FIGS. 8A-8E, the process for forming a display apparatus begins, as shown in FIG. 8A, with the formation of a first mold portion on top of a substrate. The first mold portion is formed by depositing and patterning of a first sacrificial material 804 on top of a light blocking layer 803 formed on an underlying substrate 802. The first layer of sacrificial material 804 can be or can include polyimide, polyamide, fluoropolymer, benzocyclobutene, polyphenylquinoxylene, parylene, polynorbornene, polyvinyl acetate, polyvinyl ethylene, and phenolic or novolac resins, or any of the other materials identified herein as suitable for use as a sacrificial material. Depending on the material selected for use as the first layer of sacrificial material 804, the first layer of sacrificial material 804 can be patterned using a variety of photolithographic techniques and processes such as by direct photo-patterning (for photosensitive sacrificial materials) or chemical or plasma etching through a mask formed from a photolithographically patterned resist.

Additional layers, including layers of material forming a display control matrix may be deposited below the light blocking layer 803 and/or between the light blocking layer 803 and the first sacrificial material 804. The light blocking layer 803 defines a plurality of rear apertures. The pattern defined in the first sacrificial material 804 can create recesses within which anchors for shutter assemblies will eventually be formed. In the cross-sectional views shown in FIGS. 8A-8E, neither the recesses nor the anchors for the shutter assemblies can be seen.

The process of forming the display apparatus continues with forming a second mold portion. The second mold portion is formed from depositing and patterning a second sacrificial material 806 on top of the first mold portion formed from the first sacrificial material 804. The second sacrificial material 806 can be the same type of material as the first sacrificial material 804.

FIG. 8B shows the shape of a mold 899, including the first and second mold portions, after the patterning of the second sacrificial material 806. The second sacrificial material 806 is patterned to form a recess 808 in which a rib of the shutter will eventually be formed and a recess 810 in which the side electrode will eventually be formed. The mold 899 also includes the first sacrificial material 804 with its previously defined recesses.

The process of forming the display apparatus continues with the formation of shutter assemblies using the mold, as shown in FIGS. 8C and 8D. The shutter assemblies are formed by depositing structural materials 812 onto the exposed surfaces of the mold 899, as shown in FIG. 8C, followed by patterning the structural material 812, resulting in the structure shown in FIG. 8D. The structural material 812 can include one or more layers including mechanical as well conductive layers. Suitable structural materials 812 include metals such as Al, Cu, Ni, Cr, Mo, Ti, Ta, Nb, Nd, or alloys thereof; dielectric materials such as aluminum oxide (Al₂O₃), silicon oxide (SiO₂), tantalum pentoxide (Ta₂O₅), or silicon nitride (Si₃N₄); or semiconducting materials such as diamond-like carbon, Si, Ge, GaAs, CdTe or alloys thereof. In some implementations, the structural material 812 includes a stack of materials. For example, a layer of conductive structural material may be deposited between two non-conductive layers. In some implementations, a non-conductive layer is deposited between two conductive layers. In some implementations, such a “sandwich” structure helps to ensure that stresses remaining after deposition and/or stresses that are imposed by temperature variations will not cause bending, warping or other deformation of the structural material 812. In some implementations, the structural material 812 is deposited to a thickness of less than about 2 microns. For example, the structural material 812 is deposited to have a thickness of less than about 1.5 microns.

After deposition, the structural material 812 (which may be a composite of several materials as described above) is patterned, as shown in FIG. 8D. First, a photoresist mask is deposited on the structural material 812. The photoresist is then patterned. The pattern developed into the photoresist is designed such that structural material 812, after a subsequent etch stage, remains to form a shutter 820 and the elongated electrode 822 alongside the shutter 820. The etch of the structural material 812 can be an anisotropic etch and can carried out in a plasma atmosphere with a voltage bias applied to the substrate, or to an electrode in proximity to the substrate. A second elongated electrode 824 is also formed in this process and can serve as a side electrode to a shutter that is formed adjacent to the shutter 820. For the sake of simplicity, the shutter adjacent to the shutter 820 is not shown.

The process of forming the display apparatus is completed with the removal of the mold 899. The result, shown in FIG. 8E, includes the elongated electrode 822 positioned alongside the shutter 820 at about the same height of the shutter 820. In some implementations, the mold is removed using standard MEMS release methodologies, including, for example, exposing the mold to an oxygen plasma, wet chemical etching, or vapor phase etching.

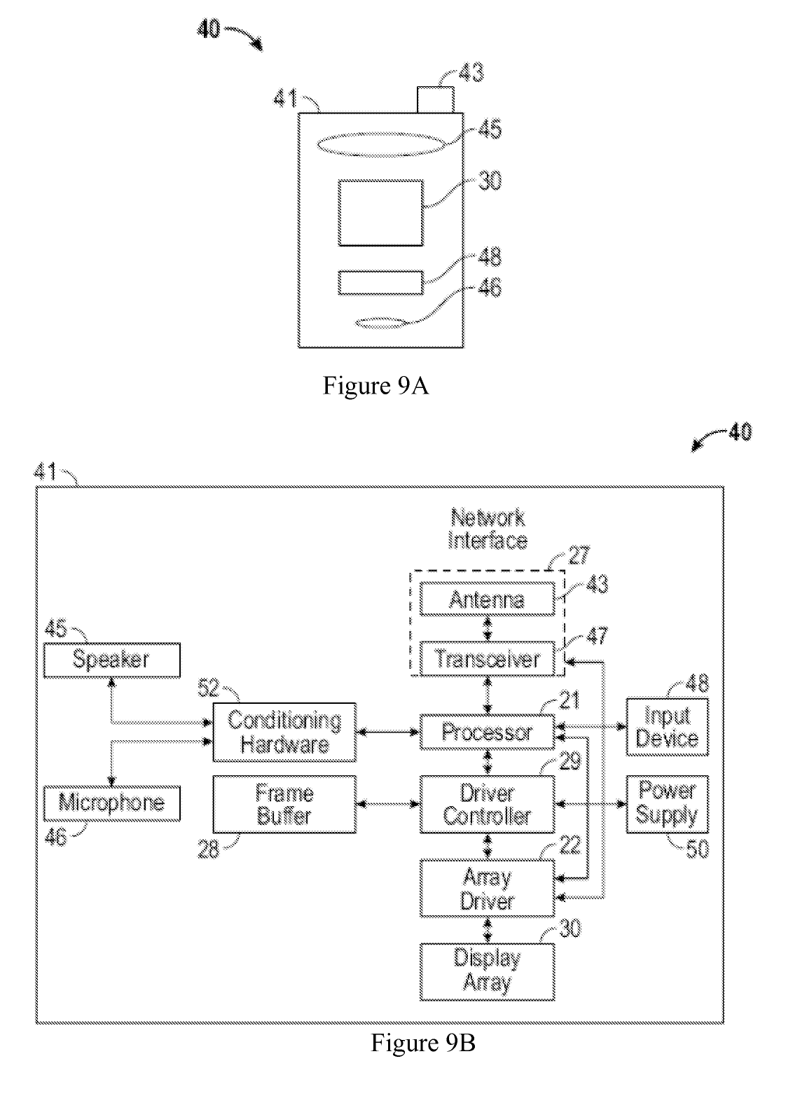

FIGS. 9A and 9B are system block diagrams illustrating a display device 40 that includes a set of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device.

The components of the display device 40 are schematically illustrated in FIG. 9B. The display device 40 includes a housing 41 and can include additional components at least partially enclosed therein. For example, the display device 40 includes a network interface 22 that includes an antenna 43 which can be coupled to a transceiver 42. The network interface 22 may be a source for image data that could be displayed on the display device 40. Accordingly, the network interface 22 is one example of an image source module, but the processor 21 and the input device 48 also may serve as an image source module. The transceiver 42 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9B, can be configured to function as a memory device and be configured to communicate with the processor 21. In some implementations, a power supply 50 can provide power to substantially all components in the particular display device 40 design.

The network interface 22 includes the antenna 43 and the transceiver 42 so that the display device 40 can communicate with one or more devices over a network. The network interface 22 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 42 can pre-process the signals received from the antenna 43 so that they may be received by and further manipulated by the processor 21. The transceiver 42 also can process signals received from the processor 21 so that they may be transmitted from the display device 40 via the antenna 43.

In some implementations, the transceiver 42 can be replaced by a receiver. In addition, in some implementations, the network interface 22 can be replaced by an image source, which can store or generate image data to be sent to the processor 21. The processor 21 can control the overall operation of the display device 40. The processor 21 receives data, such as compressed image data from the network interface 22 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller. Additionally, the array driver 22 can be a conventional driver or a bi-stable display driver. Moreover, the display array 30 can be a conventional display array or a bi-stable display array. In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a light modulator, comprising:
a conductive light blocking component supported over a light blocking layer;
an electrostatic actuator having a drive electrode configured to move the light blocking component laterally with respect to an aperture formed through the light blocking layer; and
an elongated electrode separate from the drive electrode and electrically isolated from the light blocking component, which extends alongside a path traveled by the light blocking component for substantially the entire length of the path.

2. The apparatus of claim 1, wherein during operation of the light modulator, the elongated electrode is maintained at a potential difference with respect to the light blocking component.

3. The apparatus of claim 1, wherein the elongated electrode is configured to carry a voltage across the entire length of the electrode.

4. The apparatus of claim 1, wherein the light blocking component is coupled to a cantilever beam that forms a portion of the electrostatic actuator.

5. The apparatus of claim 4, wherein the elongated electrode is curved such that the distance between the elongated electrode and the light blocking component remains substantially constant along the path traveled by the light blocking component.

6. The apparatus of claim 1, wherein the path traveled by the light blocking component is a substantially straight line.

7. The apparatus of claim 1, wherein the elongated electrode is positioned beside one side of the light blocking component and the light modulator further includes a second elongated electrode positioned on an opposite side of the light blocking component relative to the elongated electrode.

8. The apparatus of claim 1, wherein the light modulator shares the elongated electrode with a neighboring light modulator.

9. The apparatus of claim 1, wherein the elongated electrode extends parallel to the path traveled by the light blocking component.

10. The apparatus of claim 1, further comprising:
a display;
a processor that is configured to communicate with the display, the processor being configured to process image data; and
a memory device that is configured to communicate with the processor.

11. The apparatus of claim 10, further comprising:
a driver circuit configured to send at least one signal to the display; and wherein
the controller further configured to send at least a portion of the image data to the driver circuit.

12. The apparatus of claim 10, further comprising:
an image source module configured to send the image data to the processor, wherein the image source module comprises at least one of a receiver, transceiver, and transmitter.

13. The apparatus of claim 10, further comprising:
an input device configured to receive input data and to communicate the input data to the processor.

14. The apparatus of claim 10, wherein the light modulators include electromechanical system (EMS) light modulators.

15. The apparatus of claim 10, further comprising:
a first substrate configured to support an array of the light modulators; and
a second substrate separated from the first substrate.

16. An apparatus, comprising:
a light modulator, comprising:
a conductive light blocking component supported over a light blocking layer;
an electrostatic actuator having a drive means for moving the light blocking component laterally with respect to an aperture formed through the light blocking layer; and
a plane maintaining means for restricting the light blocking component from moving away from its desired path of travel, the plane maintaining means separate from the drive means, and which extends alongside a path traveled by the movable light blocking component for substantially the entire length of the path.

17. The apparatus of claim 16, wherein during operation of the light modulator, the plane maintaining means is maintained at a potential difference with respect to the light blocking component.

18. The apparatus of claim 16, wherein the elongated electrode means is configured to carry a voltage across the entire length of the plane maintaining means.

19. The apparatus of claim 16, wherein the light blocking component is coupled to a cantilever beam that forms a portion of the electrostatic actuator; and
wherein the plane maintaining means is curved such that the distance between the elongated electrode and the light blocking component remains substantially constant along the path traveled by the movable light blocking component.

20. The apparatus of claim 16, wherein the plane maintaining means is positioned beside one side of the light blocking component and the light modulator further includes a second plane maintaining means positioned on an opposite side of the light blocking component relative to the plane maintaining means.
